(19) United States
(12) Patent Application Publication
(10) Pub. No.: US 2026/0095779 A1
(43) Pub. Date: Apr. 2, 2026

(54) RADIO LINK CONTROL UNACKNOWLEDGED MODE SEQUENCE NUMBER CONTINUITY ACROSS COMPONENT CARRIERS

(71) Applicant: QUALCOMM Incorporated, San Diego, CA (US)

(72) Inventors: Sitaramanjaneyulu KANAMARLAPUDI, San Diego, CA (US); Leena ZACHARIAS, San Jose, CA (US)

(21) Appl. No.: 18/899,805

(22) Filed: Sep. 27, 2024

(51) Int. Cl. H04W 24/02; H04L 1/1607; H04L 5/00

(52) U.S. Cl. CPC H04W 24/02; H04L 1/1642; H04L 5/001

(57) ABSTRACT

Various aspects of the present disclosure generally relate to wireless communication. In some aspects, a transmitter device may segment a radio link control (RLC) unacknowledged mode (UM) packet into first and second RLC UM protocol data units (PDUs) for transmission via a carrier component (CC) of a plurality of CCs, wherein CC, of the plurality of CCs, is associated with a respective set of RLC UM sequence numbers (SNs) starting from a respective starting SN and separated by an offset greater than one. The transmitter device may transmit the first and second RLC UM PDUs via the CC, the first and second RLC UM PDUs including first and second RLC UM headers, respectively, each indicating an RLC UM SN from the respective set of RLC UM SNs associated with the CC. Numerous other aspects are described.

### FIELD OF THE DISCLOSURE

Aspects of the present disclosure generally relate to wireless communication and specifically relate to techniques, apparatuses, and methods associated with radio link control unacknowledged mode sequence number continuity across component carriers.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a transmitter device for wireless communication. The transmitter device may include one or more memories and one or more processors coupled to the one or more memories. The one or more processors may be individually or collectively configured to segment a radio link control (RLC) unacknowledged mode (UM) packet into a first RLC UM protocol data unit (PDU) and a second RLC UM PDU for transmission via a carrier component (CC) of a plurality of CCs, wherein each CC, of the plurality of CCs, is associated with a respective set of RLC UM sequence numbers (SNs) starting from a respective starting SN and separated by an offset greater than one. The one or more processors may be individually or collectively configured to transmit the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Some aspects described herein relate to a receiver device for wireless communication. The receiver device may include one or more memories and one or more processors coupled to the one or more memories. The one or more processors may be individually or collectively configured to receive segments of an RLC UM packet associated with an RLC UM SN. The one or more processors may be individually or collectively configured to deliver the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a packet data convergence protocol (PDCP) SN included in the RLC UM packet being a next expected PDCP SN.

Some aspects described herein relate to a receiver device for wireless communication. The receiver device may include one or more memories and one or more processors coupled to the one or more memories. The one or more processors may be individually or collectively configured to receive segments of a RLC UM packet associated with an RLC UM SN. The one or more processors may be individually or collectively configured to deliver the RLC UM packet without starting a reassembly timer in connection with detection, using an artificial intelligence (AI) or machine learning (ML) (AI/ML) model, that a gap between the RLC UM SN and a previous RLC UM SN, associated with a previously received RLC UM packet, corresponds to an RLC UM SN jump across different CCs of a plurality of CCs.

Some aspects described herein relate to a method of wireless communication performed by a transmitter device. The method may include segmenting an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one. The method may include transmitting the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Some aspects described herein relate to a method of wireless communication performed by a receiver device. The method may include receiving segments of an RLC UM packet associated with an RLC UM SN. The method may include delivering the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

Some aspects described herein relate to a method of wireless communication performed by a receiver device. The method may include receiving segments of an RLC UM packet associated with an RLC UM SN. The method may include delivering the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs.

Some aspects described herein relate to a non-transitory computer-readable medium that stores a set of instructions for wireless communication by a transmitter device. The set of instructions, when executed by one or more processors of the transmitter device, may cause the transmitter device to segment an RLC UM packet into a first RLC UM PDU and a second RLC UM PDU for transmission via CC of a plurality of CCs, wherein each CC, of the plurality of CCs, is associated with a respective set of RLC UM SNs starting from a respective starting SN and separated by an offset greater than one. The set of instructions, when executed by one or more processors of the transmitter device, may cause the transmitter device to transmit the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Some aspects described herein relate to a non-transitory computer-readable medium that stores a set of instructions for wireless communication by a receiver device. The set of instructions, when executed by one or more processors of the receiver device, may cause the receiver device to receive segments of an RLC UM packet associated with an RLC UM SN. The set of instructions, when executed by one or more processors of the receiver device, may cause the receiver device to deliver the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

Some aspects described herein relate to a non-transitory computer-readable medium that stores a set of instructions for wireless communication by a receiver device. The set of instructions, when executed by one or more processors of the receiver device, may cause the receiver device to receive segments of an RLC UM packet associated with an RLC UM SN. The set of instructions, when executed by one or more processors of the receiver device, may cause the receiver device to deliver the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs.

Some aspects described herein relate to an apparatus for wireless communication. The apparatus may include means for segmenting an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one. The apparatus may include means for transmitting the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Some aspects described herein relate to an apparatus for wireless communication. The apparatus may include means for receiving segments of an RLC UM packet associated with an RLC UM SN. The apparatus may include means for delivering the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

Some aspects described herein relate to an apparatus for wireless communication. The apparatus may include means for receiving segments of an RLC UM packet associated with an RLC UM SN. The apparatus may include means for delivering the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a user plane protocol stack and a control plane protocol stack for a network node and a core network in communication with a user equipment, in accordance with the present disclosure.

FIG. 4 is a diagram illustrating an example associated with radio link control unacknowledged mode sequence number continuity across component carriers, in accordance with the present disclosure.

FIG. 5 is a diagram illustrating an example process performed, for example, at a transmitter device or an apparatus of a transmitter device, in accordance with the present disclosure.

FIG. 6 is a diagram illustrating an example process performed, for example, at a receiver device or an apparatus of a receiver device, in accordance with the present disclosure.

FIG. 7 is a diagram illustrating an example process performed, for example, at a receiver device or an apparatus of a receiver device, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Radio link control (RLC) is a layer 2 (L2) protocol that is located on top of (e.g., above) a medium access control (MAC) layer and below a packet data convergence protocol (PDCP) layer in a 5G New Radio (NR) protocol stack. The RLC layer may handle transfer of upper layer protocol data units (PDUs) to the MAC and/or physical (PHY) layers, segmentation and reassembly of RLC service data units (SDUs), and error correction via automatic repeat requests (ARQ) (e.g., in an acknowledged mode (AM)), among other examples. The RLC layer may perform data transfer in one of three modes: the AM, an unacknowledged mode (UM), or a transparent mode (TM). Functions of the RLC layer may be performed by RLC entities. For an RLC entity configured at a network node, there may be a peer RLC entity configured at a user equipment (UE), and vice versa. An RLC entity in a transmitter device (e.g., a network node or a UE), may receive RLC SDUs from an upper layer and send RLC PDUs to a peer RLC entity in a receiver device (e.g., a UE or a network node) via lower layers. An RLC entity in a receiver device may receive RLC PDUs from a peer entity in a transmitter device via lower layers and deliver RLC SDUs to an upper layer. An RLC entity may be configured to perform data transfer in the AM, the UM, or the TM. That is, an RLC entity may be an RLC AM entity (also referred to as “AM RLC entity”), an RLC UM entity (also referred to as “UM RLC entity”), or an RLC TM entity (also referred to as “TM RLC entity”).

In RLC UM, RLC data is transmitted with an RLC header (e.g., an RLC UM header), and there is no feedback (e.g., acknowledgement (ACK) or negative acknowledgement (NACK) feedback) for the transmitted RLC data transmitted. The behavior of an RLC UM entity may be defined in a wireless communication standard (e.g., a Third Generation Partnership Project (3GPP) wireless communication standard). An RLC UM transmitting entity (also referred to as “transmitting UM RLC entity”) may transmit a packet with or without segmentation. Segmentation (e.g., RLC segmentation) refers to splitting an RLC SDU (e.g., an RLC UM SDU) into multiple RLC PDUs (e.g., multiple RLC UM PDUs) for transmission in different transport blocks (TBs). The RLC UM SDU may include a packet (e.g., an internet protocol (IP) packet may be encapsulated in the RLC UM SDU along with a PDCP header and/or a service data adaptation protocol (SDAP) header). Accordingly, the segmentation may split a packet into multiple segments (e.g., each segment included in a respective RLC UM PDU).

The RLC UM transmitting entity may determine whether or not to perform segmentation based on a grant at a MAC TB level and an amount of space (e.g., a number of bytes) available in a MAC TB. In some examples, the MAC layer may inform the RLC layer about the about a size of a MAC TB and/or an amount of space available in the MAC TB. If the entire packet (e.g., all the bytes of an RLC UM PDU including the entire RLC UM SDU) can be transmitted in the same MAC TB, then the RLC UM transmitting entity does not perform segmentation. In this case, the RLC UM transmitting entity sends the entire packet (e.g., one RLC UM PDU including the entire RLC UM SDU) completely in one transmission (e.g., in one MAC TB). If the entire packet (e.g., an RLC UM PDU including the entire RLC UM SDU) cannot be transmitted in the same MAC TB (e.g., the size of the RLC UM SDU is larger than the available space in a MAC TB), then the RLC UM transmitting entity performs segmentation. In this case, the RLC UM transmitting entity splits the RLC UM SDU into multiple RLC UM PDUs to be transmitted in different MAC TBs.

When the RLC UM SDU is segmented into multiple RLC UM PDUs, the RLC UM header of each RLC UM PDU may indicate an RLC UM sequence number (SN) and segmentation information to ensure that an RLC UM receiving entity (also referred to as “receiving UM RLC entity”) in the RLC layer of the receiver device can reassemble the correct set of segments that are associated with the same RLC UM SN into an RLC UM SDU. Accordingly, all of the segments (e.g., the RLC UM PDUs) of a packet (e.g., the RLC UM SDU) are assigned the same RLC UM SN. Due to the presence of the RLC UM SN in the RLC UM PDUs received at the receiver device, the RLC layer of the receiver device may process the received RLC UM PDUs in accordance with reassembly window logic and deliver reassembled packets (e.g., reassembled RLC UM SDUs) to an upper layer in sequence or in connection with expiry of a reassembly timer. In some examples, a reassembly window may define a range of RLC UM SNs for which the RLC layer of the receiver device may perform RLC reassembly. The receiver device may manage the reassembly window such that once a packet (e.g., a reassembled RLC UM SDU) associated with an RLC UM SN is delivered from the RLC layer to an upper layer, a lower edge of the reassembly window (e.g., defining a minimum RLC UM SN in the reassembly window) is moved to a next expected RLC UM SN after the RLC UM SN associated with the delivered packet. Any received RLC UM PDUs associated with an RLC UM SN that is below the next expected RLC UM SN (e.g., below the lower edge of the reassembly window) will be discarded as out-of-window (OOW). If the receiver device, receives RLC UM PDUs associated with an RLC UM SN that is greater than the next expected RLC UM SN (e.g., there is a gap between the RLC UM SN and the RLC UM SN associated with the most recent delivered packet), the receiver device starts the reassembly timer. The reassembly timer runs for a time duration to provide time for previous missing RLC UM PDUs (e.g., associated with a lower RLC UM SN) to arrive (e.g., with hybrid ARQ (HARQ) scheduling delays and retransmission logic). Upon expiry of the reassembly timer, the RLC layer of the receiver device delivers the packet (e.g., the reassembled RLC UM SDU) reassembled from the RLC UM PDUs associated with the RLC UM SN, and then moves the lower edge of the reassembly window accordingly. In some examples, the reassembly window management behavior and the reassembly timer (e.g., the time duration of the reassembly timer) may be specified in a wireless communication standard (e.g., a 3GPP wireless communication standard). In some examples, the size of the reassembly window may be based on, or otherwise associated with, an RLC UM SN space (e.g., a quantity and/or range of RLC UM SNs) configured for a radio bearer.

In RLC UM, when an entire packet (e.g., an RLC UM PDU including an entire RLC UM SDU) is transmitted completely in one transmission (e.g., in one MAC TB), no RLC UM SN is included in the ULC UM header of the RLC UM PDU. In this case, the RLC UM header may include, in an SI field, an indication that the RLC UM PDU contains a complete RLC UM SDU. When such an RLC UM PDU with no RLC UM SN is received at the RLC layer of the receiving device, the RLC layer delivers the RLC UM PDU to an upper layer (e.g., the PDCP layer) without performing RLC reassembly (e.g., without applying reassembly logic to the RLC UM PDU).

In some examples, a transmitter device (e.g., a network node or a UE) and a receiver device (e.g., a UE or a network node) may communicate via multiple component carriers (CCs) (sometimes referred to as “carriers”) using carrier aggregation. Carrier aggregation is a technology that enables two or more CCs to be combined (e.g., into a single channel) for a UE to enhance data capacity. CCs can be combined in the same or different frequency bands. Additionally, or alternatively, contiguous or non-contiguous CCs can be combined. For example, a network node may configure carrier aggregation for a UE. In this case, while the RLC UM behavior is defined at the RLC layer, packets can be transmitted (e.g., to the UE and/or from the UE) via a single CC or multiple CCs depending on a carrier aggregation configuration at the MAC and/or PHY layer. The carrier aggregation configuration may be based on a scheduling policy and/or load balancing for high throughput use cases and/or low latency use cases, among other examples. In some examples, the network (e.g., the network node) may determine and/or adjust the carrier aggregation configuration for the UE based on, or otherwise associated with, UE metrics, network conditions, and/or traffic quality of service (QoS) requirements, among other examples.

The determination of whether or not to segment a packet (e.g., an RLC UM SDU) into multiple RLC UM PDUs (e.g., and thus whether or not to include an RLC UM header indicating the RLC UM SN) may be based on the grant at the MAC TB level and a comparison of the amount of space available (e.g., a number of bytes allowed) to be transmitted and a size of an RLC UM PDU including the entire packet. In some examples, a time offset between the grant and the transmission of the MAC TB may be very short. The MAC layer may generate separate MAC TBs for the CCs in parallel. Even though the RLC segmentation may be happening at a MAC TB that is specific for a particular CC, the RLC UM SN has to be maintained at the RLC level and across all of the CCs in order to maintain a first come first served (FCFS) model of delivery. That is, the RLC UM SNs are maintained at an RLC bearer level, rather than at MAC CC level. In some examples, when configured with carrier aggregation and scheduling RLC UM PDUs in downlink, the transmitter device (e.g., a network node) must determine, based on the final grant on each CC, whether to include the RLC UM SN in each RLC UM header. In this case, multiple CCs may be scheduled in parallel with hardware accelerators and schedulers specific to each CC, and as such, it may not be feasible to synchronize the RLC UM SNs across the CCs in real time. As a result, duplicate RLC UM SNs may be assigned to RLC UM PDUs associated with different packets that are transmitted in parallel on different CCs. This may result in some packets being incorrectly discarded as duplicates by the receiver device, which may reduce reliability and throughput of the data transmitted from the transmitter device to the receiver device.

Various aspects relate generally to RLC UM SNs. Some aspects more specifically relate to RLC UM SN continuity across multiple component carriers. In some aspects, a transmitter device may segment an RLC UM packet into a first RLC UM PDU and a second RLC PDU for transmission via a CC of a plurality of CCs. Each CC, of the plurality of CCs, may be associated with a respective set of RLC SNs. Each respective set of RLC SNs may start from a respective starting SN and be separated by an offset greater than one. The transmitter device may transmit the first RLC UM PDU and the second RLC UM PDU via the CC. The first RLC UM PDU may include a first RLC UM header indicating an RLC UM SN from the respective set of RLC UM SNs associated with the CC, and the second RLC UM PDU may include a second RLC UM header indicating the RLC UM SN from the respective set of RLC UM SNs associated with the CC.

Particular aspects of the subject matter described in this disclosure can be implemented to realize one or more of the following potential advantages. In some examples, by associating each CC, of the plurality of CCs, with a respective set of RLC UM SNs starting from a respective starting SN and separated by an offset greater than one, and transmitting the first and second RLC UM PDUs with the respective first and second RLC UM headers indicating the RLC UM SN from the respective set of RLC UM SNs associated with the CC on which the first and second RLC UM PDUs are transmitted, the described techniques can be used to reduce duplicate RLC UM SNs assigned to RLC UM PDUs, associated with different packets, that are transmitted on different CCs, and thus increase reliability and throughput for data transmitted by the transmitter device.

In some aspects, the transmitter device may coordinate across the plurality of CCs at a reoccurring time interval to synchronize the respective set of RLC UM SNs for each CC of the plurality of CCs with respect to a highest RLC UM SN previously assigned across the plurality of CCs. In some examples, by coordinating across the plurality of CCs at a reoccurring time interval to synchronize the respective set of RLC UM SNs for each CC of the plurality of CCs with respect to a highest RLC UM SN previously assigned across the plurality of CCs, the described techniques can be used to further reduce discarded packets and further increase reliability and throughput of data transmitted by the transmitter device by preventing the transmitter device from assigning, to RLC UM PDUs in one CC, an RLC UM SN that is outside of a reassembly window due to a higher RLC UM SN being previously assigned to RLC UM PDUs in another CC.

In some aspects, a receiver device may receive segments of an RLC UM packet associated with an RLC UM SN. The receiver device may deliver the RLC UM packet without starting a reassembly timer associated with a gap between the RLC UM SN and a previously received RLC UM, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

Particular aspects of the subject matter described in this disclosure can be implemented to realize one or more of the following potential advantages. In some examples, by delivering the RLC UM packet without starting the reassembly timer associated with the gap between the RLC UM SN and the previously received RLC UM SN in connection with the segments of the RLC UM packet being received via a CC, of a plurality of CCs, different from a CC via which the previously received RLC UM packet was received, and in connection with the PDCP SN included in the RLC UM packet being a next expected PDCP SN, the described techniques can be used to reduce latency due to a jump in RLC UM SNs between in-sequence packets, and to improve traffic throughput and user experience at an application level.

In some aspects, a receiver device may receive segments of an RLC UM packet associated with an RLC UM SN. The receiver device may detect a gap between the RLC UM SN and a previous RLC UM SN associated with a previously received RLC UM packet. The receiver device may deliver the RLC UM packet without starting a reassembly timer in connection with detection, using an artificial intelligence (AI) or machine learning (ML) (AI/ML) model, that a gap between the RLC UM SN and the previous RLC UM SN, associated with a previously received RLC UM packet, corresponds to an RLC UM SN jump across different CCs of a plurality of CCs.

Particular aspects of the subject matter described in this disclosure can be implemented to realize one or more of the following potential advantages. In some examples, by delivering the RLC UM packet without starting the reassembly timer in connection with detecting, using an AI/ML model, that the gap between the RLC UM SN and the previous RLC UM SN corresponds to an RLC UM SN jump across different CCs of a plurality of CCs, the described techniques can be used to reduce latency due to a jump in RLC UM SNs for packets received across different CCs, and to improve traffic throughput and user experience at an application level.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the 3GPP. 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

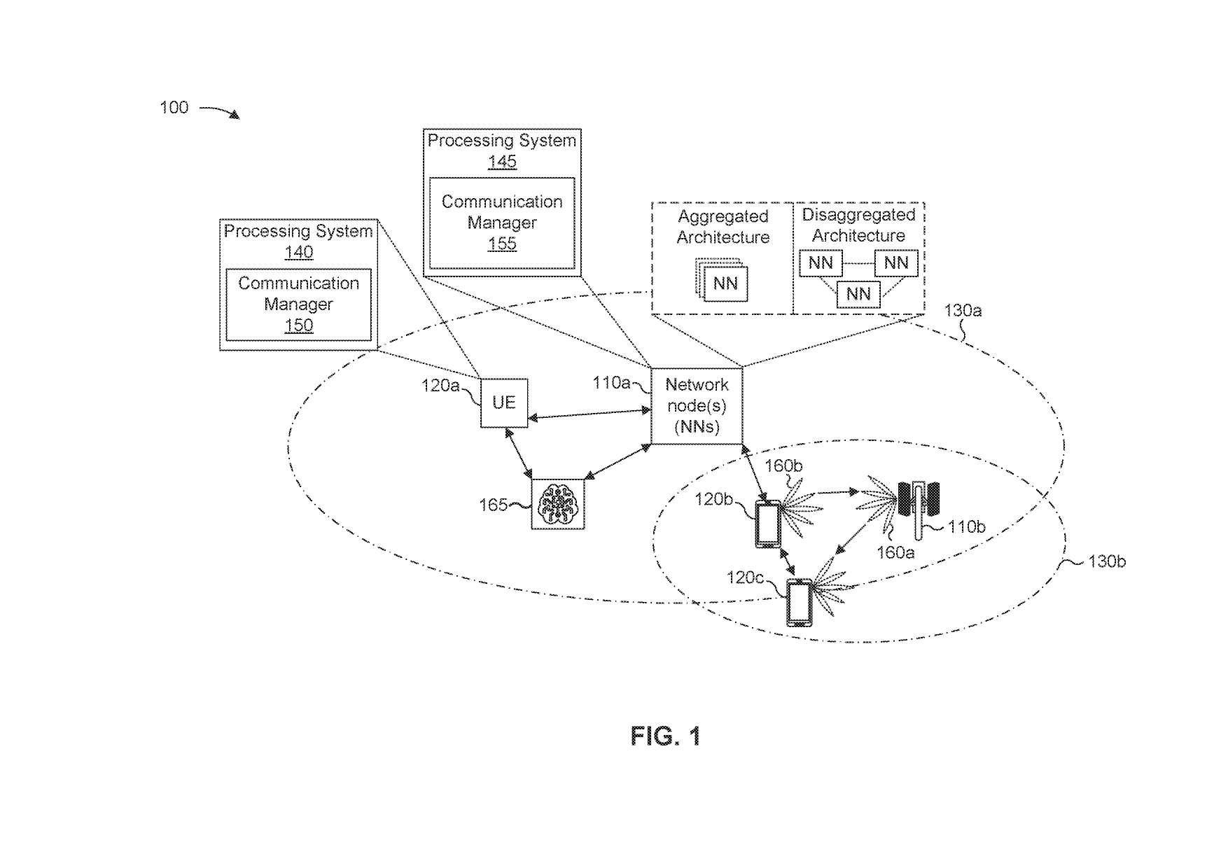

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

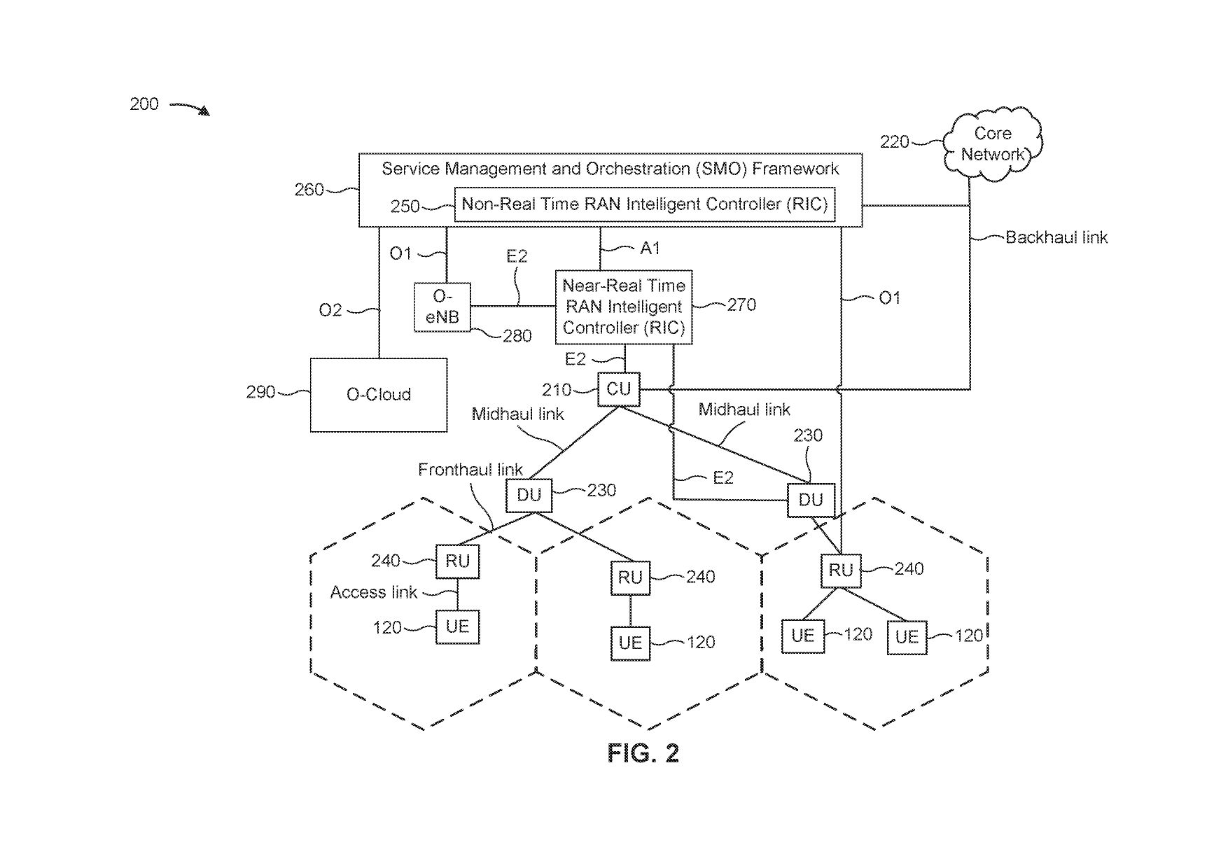

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a PDCP layer, and an SDAP layer, among other examples. A DU may host one or more of an RLC layer, a MAC layer, and/or one or more higher PHY layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 uses to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 uses to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an AI program (for example, referred to herein as an “AI/ML model”), such as a program that includes an ML model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may segment an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one; and transmit the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Additionally, or alternatively, as described in more detail elsewhere herein, the communication manager 150 may receive segments of an RLC UM packet associated with an RLC UM SN; and deliver the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

Additionally, or alternatively, as described in more detail elsewhere herein, the communication manager 150 may receive segments of an RLC UM packet associated with an RLC UM SN; and deliver the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs. Additionally, or alternatively, the communication manager 150 may perform one or more other operations described herein.

In some aspects, the network node 110 may include a communication manager 155. As described in more detail elsewhere herein, the communication manager 155 may segment an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one; and transmit the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Additionally, or alternatively, as described in more detail elsewhere herein, the communication manager 155 may receive segments of an RLC UM packet associated with an RLC UM SN; and deliver the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

Additionally, or alternatively, as described in more detail elsewhere herein, the communication manager 155 may receive segments of an RLC UM packet associated with an RLC UM SN; and deliver the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

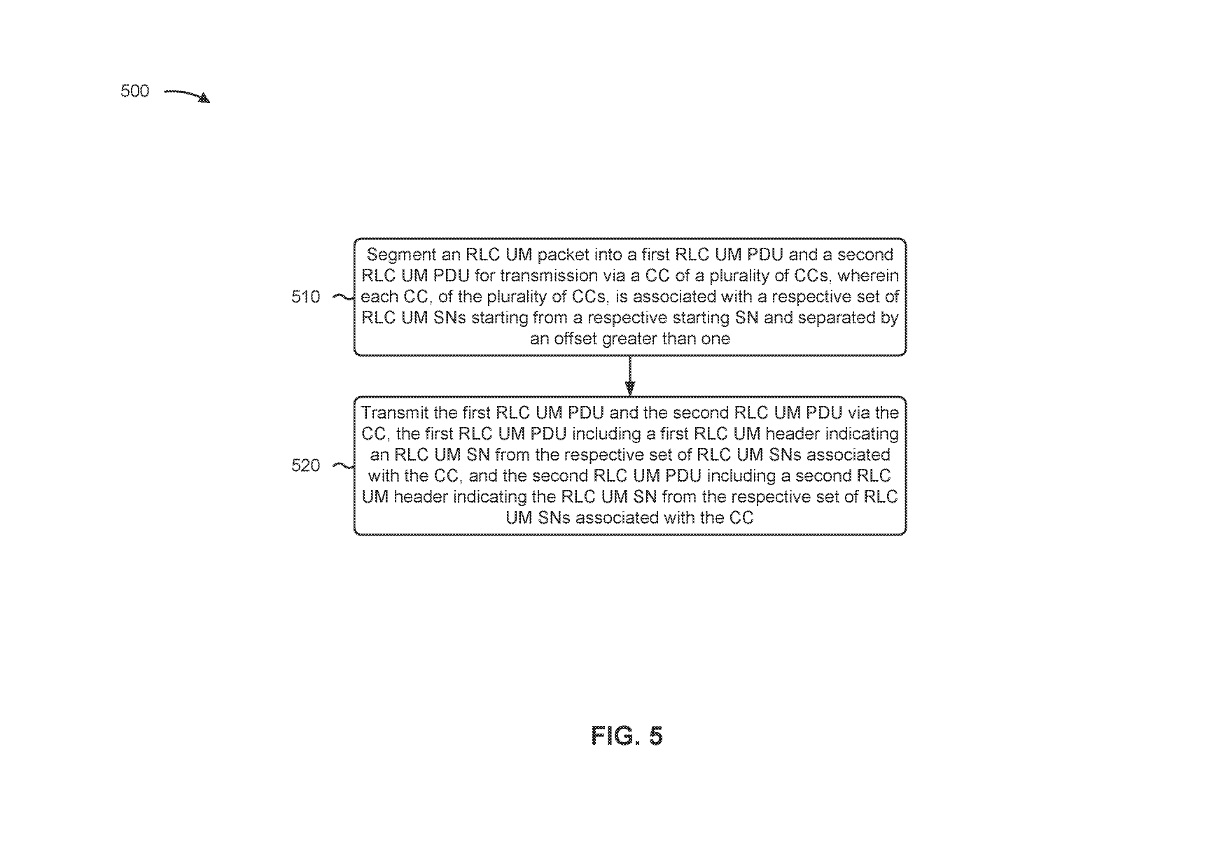

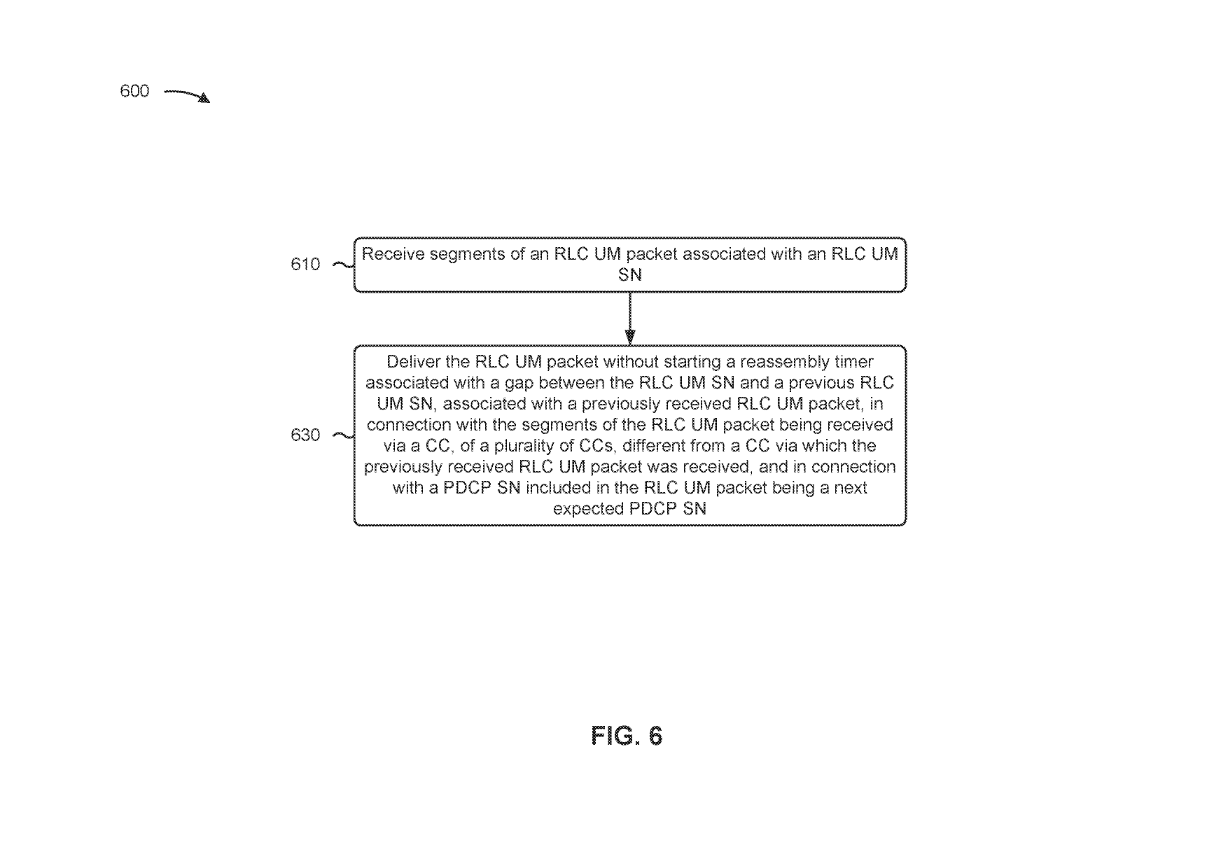

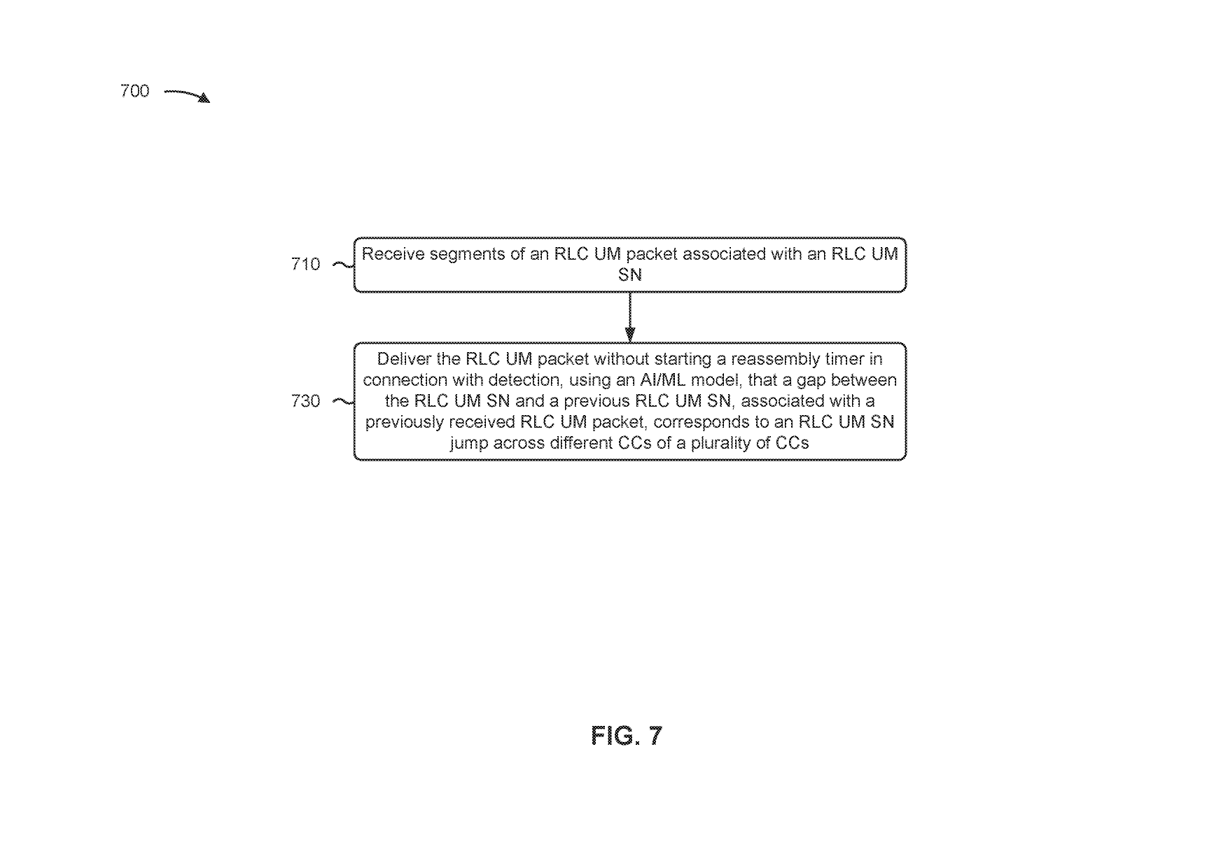

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with RLC UM SN continuity across CCs, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, process 700 of FIG. 7, or other processes as described herein. In some examples, executing instructions may include running the instructions, converting the instructions, compiling the instructions, and/or interpreting the instructions, among other examples. In some aspects, the transmitter device described herein is the network node 110, is included in the network node 110, or includes one or more components of the network node 110 shown in FIG. 1. In some aspects, the transmitter device described herein is the UE 120, is included in the UE 120, or includes one or more components of the UE 120 shown in FIG. 1. In some aspects, the receiver device described herein is the UE 120, is included in the UE 120, or includes one or more components of the UE 120 shown in FIG. 1. In some aspects, the receiver device described herein is the network node 110, is included in the network node 110, or includes one or more components of the network node 110 shown in FIG. 1.

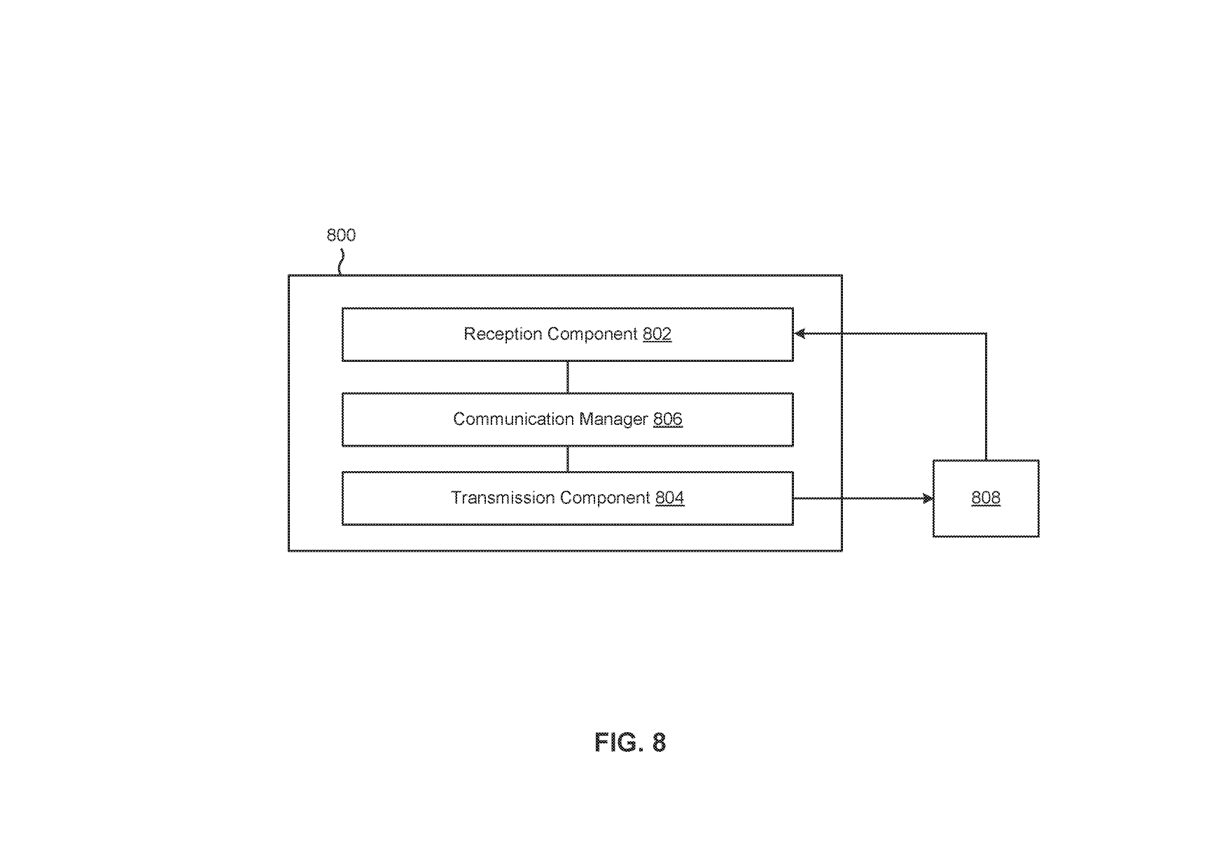

In some aspects, a transmitter device (e.g., a network node 110 or a UE 120) includes means for segmenting an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one; and/or means for transmitting the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC. In some aspects, the means for the transmitter device to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8) and/or a transmission component (for example, transmission component 804 depicted and described in connection with FIG. 8), among other examples. In some aspects, the means for the transmitter device to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8) and/or a transmission component (for example, transmission component 804 depicted and described in connection with FIG. 8), among other examples.

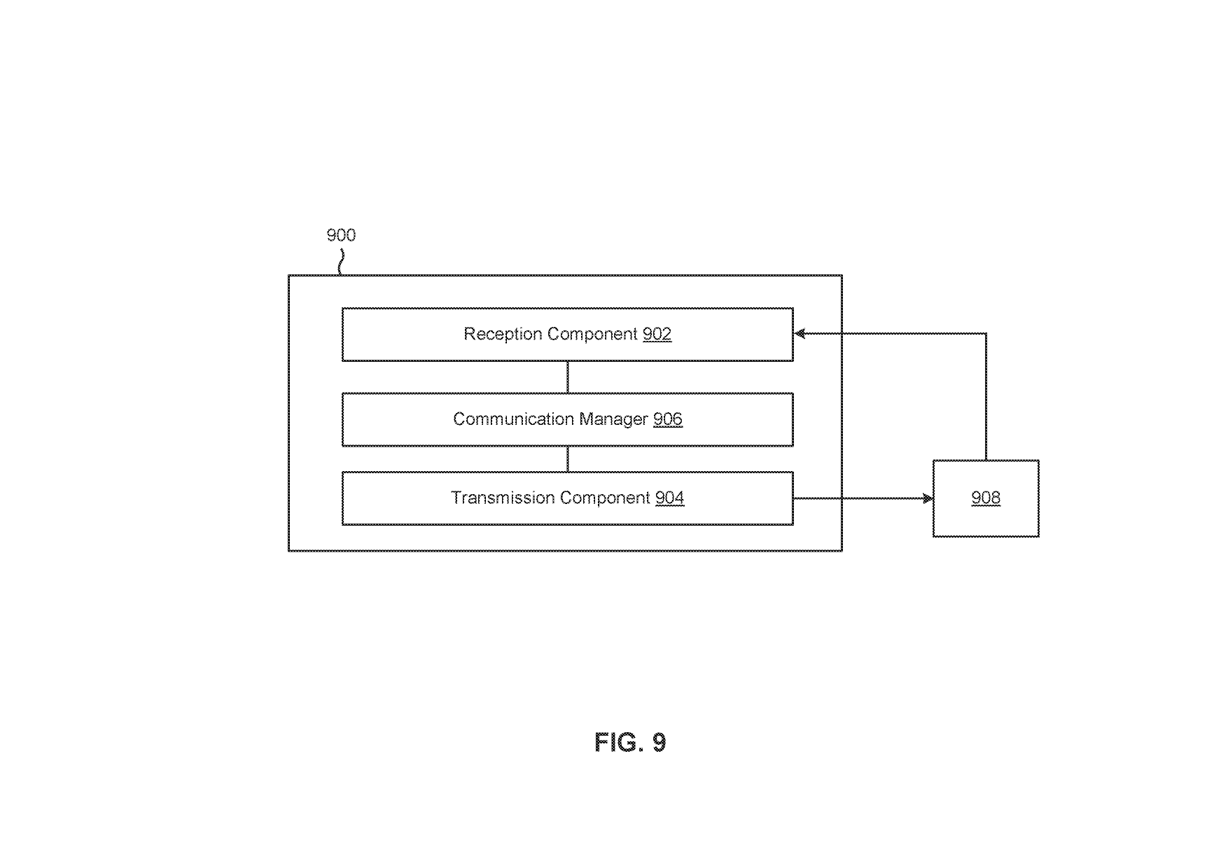

In some aspects, a receiver device (e.g., a UE 120 or a network node 110) includes means for receiving segments of an RLC UM packet associated with an RLC UM SN; and/or means for delivering the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN. In some aspects, the means for the receiver device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9) and/or a transmission component (for example, transmission component 904 depicted and described in connection with FIG. 9), among other examples. In some aspects, the means for the receiver device to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

In some aspects, a receiver device (e.g., a UE 120 or a network node 110) includes means for receiving segments of an RLC UM packet associated with an RLC UM SN; and/or means for delivering the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs. In some aspects, the means for the receiver device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9) and/or a transmission component (for example, transmission component 904 depicted and described in connection with FIG. 9), among other examples. In some aspects, the means for the receiver device to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

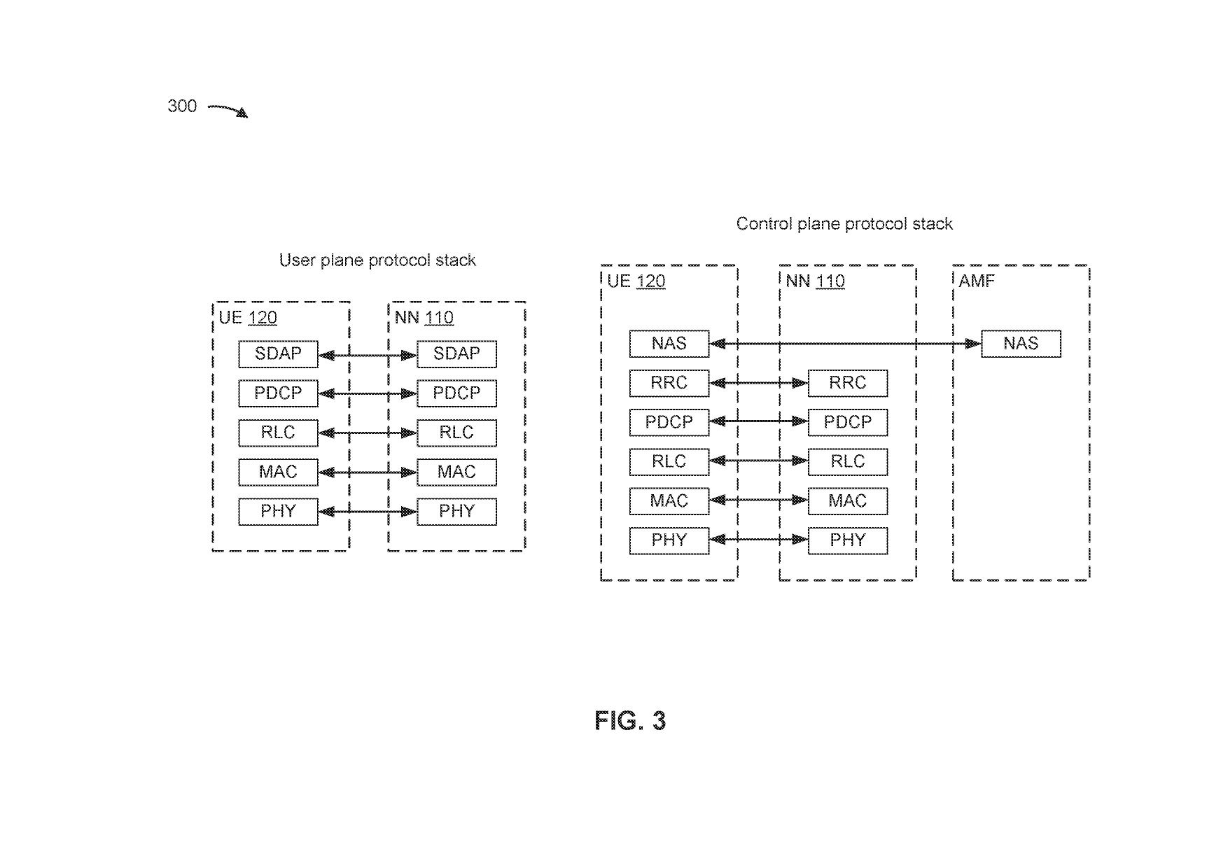

FIG. 3 is a diagram illustrating an example 300 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to "a network node 110" or "the network node 110" can, in some aspects, refer to multiple network nodes.

On the user plane, the UE 120 and the network node 110 may include respective PHY layers, MAC layers, RLC layers, PDCP layers, and SDAP layers. A user plane function may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); QoS management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as L2. Thus, in some cases, the SDAP, PDCP, RLC, and MAC layers are referred to as sublayers of L2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP PDU routing (in case of split bearers), retransmission of PDCP SDUs, ciphering and deciphering, PDCP SDU discard (e.g., in accordance with a timer, as described elsewhere herein), PDCP re-establishment and data recovery for RLC AM, and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via ARQ (e.g., for RLC AM), segmentation and reassembly of an RLC SDU, RLC SDU discard, and RLC re-establishment. The RLC layer may perform data transfer in one of three modes: RLC AM, RLC UM, or RLC TM. Functions of the RLC layer may be performed by RLC entities. For an RLC entity configured at a network node 110, there may be a peer RLC entity configured at the UE 120, and vice versa.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the physical layer on transport channels, scheduling information reporting, error correction through HARQ, priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as L1.

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the SDAP layer may receive a packet (e.g., an IP packet) from an upper layer (e.g., the APP layer) as an SDAP SDU. A given layer may then encapsulate the unit of data into a PDU and may pass the PDU to a lower layer. For example, the SDAP layer may encapsulate the SDAP SDU into an SDAP PDU (e.g., by adding an SDAP header to the SDAP SDU) and may pass the SDAP PDU to the PDCP layer. The PDCP layer may receive the SDAP PDU as a PDCP SDU, may encapsulate the PDCP SDU into a PDCP PDU (e.g., by adding a PDCP header to the PDCP SDU), and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

In RLC UM, RLC data is transmitted with an RLC header (e.g., an RLC UM header), and there is no feedback (e.g., ACK or NACK) feedback for the transmitted RLC data transmitted. On the transmitting side, in RLC UM, the RLC layer (e.g., an RLC UM transmitting entity) may transmit a packet with or without segmentation. Segmentation (e.g., RLC segmentation) refers to splitting an RLC SDU (e.g., an RLC UM SDU) into multiple RLC PDUs (e.g., multiple RLC UM PDUs) for transmission in different transport blocks (TBs). The RLC UM SDU may include a packet (e.g., an IP packet may be encapsulated in the RLC UM SDU along with a PDCP header and/or an SDAP header). Accordingly, the segmentation may split a packet into multiple segments (e.g., each segment included in a respective RLC UM PDU). the RLC layer (e.g., an RLC UM transmitting entity) may determine whether or not to perform segmentation based on a grant at a MAC TB level and an amount of space (e.g., a number of bytes) available in a MAC TB. In some examples, the MAC layer may inform the RLC layer about the about a size of a MAC TB and/or an amount of space available in the MAC TB. If the entire packet (e.g., all the bytes of an RLC UM PDU including the entire RLC UM SDU) can be transmitted in the same MAC TB, then the RLC UM transmitting entity does not perform segmentation. In this case, the RLC UM transmitting entity transmits the entire packet (e.g., one RLC UM PDU including the entire RLC UM SDU) completely in one transmission (e.g., in one MAC TB). If the entire packet (e.g., an RLC UM PDU including the entire RLC UM SDU) cannot be transmitted in the same MAC TB (e.g., the size of the RLC UM SDU is larger than the available space in a MAC TB), then the RLC UM transmitting entity performs segmentation. In this case, the RLC UM transmitting entity splits the RLC UM SDU into multiple RLC UM PDUs to be transmitted in different MAC TBs.

In RLC UM, when the RLC UM SDU is segmented into multiple RLC UM PDUs (also referred to as UM data (UMD) PDUs), the RLC UM header of each RLC UM PDU may indicate an RLC UM SN and segmentation information to ensure that an RLC UM receiving entity (also referred to as “receiving UM RLC entity”) in the RLC layer of the receiver device can reassemble the correct set of segments that are associated with the same RLC UM SN into an RLC UM SDU. All of the segments (e.g., the RLC UM PDUs) of a packet (e.g., the RLC UM SDU) are assigned the same RLC UM SN. Additionally, or alternatively, the segmentation information, included in each RLC UM header, may include an indication in a segmentation information (SI) field (e.g., that indicates whether the RLC UM PDU contains a complete RLC UM SDU, a first segment of an RLC UM SDU, a middle segment of an RLC UM SDU, or a last segment of an RLC UM SDU) and/or a segment offset associated with the RLC UM PDU (e.g., only for a middle segment and the last segment of an RLC UM SDU).

On the receiving side, due to the presence of the RLC UM SN in the RLC UM PDUs received at the receiver device, the RLC layer may process received RLC UM PDUs in accordance with reassembly window logic and deliver reassembled packets (e.g., reassembled RLC UM SDUs) to an upper layer in sequence or in connection with expiry of a reassembly timer. In some examples, a reassembly window may define a range of RLC UM SNs for which the RLC layer of a receiver device (e.g., an RLC UM receiving entity) may perform RLC reassembly. The RLC layer of the receiver device may manage the reassembly window such that once a packet (e.g., a reassembled RLC UM SDU) associated with an RLC UM SN is delivered from the RLC layer to an upper layer (e.g., the PDCP layer), a lower edge of the reassembly window (e.g., defining a minimum RLC UM SN in the reassembly window) is moved to a next expected RLC UM SN after the RLC UM SN associated with the delivered packet. Any received RLC UM PDUs associated with an RLC UM SN that is below the next expected RLC UM SN (e.g., below the lower edge of the reassembly window) will be discarded as OOW. If the RLC layer of the receiver device, receives RLC UM PDUs associated with an RLC UM SN that is greater than the next expected RLC UM SN (e.g., there is a gap between the RLC UM SN and the previous RLC UM SN associated with the most recent delivered packet), the receiver device starts the reassembly timer. The reassembly timer runs for a time duration to provide time for previous missing RLC UM PDUs (e.g., associated with a lower RLC UM SN) to arrive (e.g., with HARQ scheduling delays and retransmission logic). Upon expiry of the reassembly timer, the RLC layer of the receiver device delivers the packet (e.g., the reassembled RLC UM SDU) reassembled from the RLC UM PDUs associated with the RLC UM SN, and then moves the lower edge of the reassembly window accordingly. In some examples, the reassembly window management behavior and the reassembly timer (e.g., the time duration of the reassembly timer) may be specified in a wireless communication standard (e.g., a 3GPP wireless communication standard). In some examples, the size of the reassembly window may be based on, or otherwise associated with, an RLC UM SN space (e.g., a quantity and/or range of RLC UM SNs) configured for a radio bearer.

In RLC UM, when an entire packet (e.g., an RLC UM PDU including an entire RLC UM SDU) is transmitted completely in one transmission (e.g., in one MAC TB), no RLC UM SN is included in the ULC UM header of the RLC UM PDU. In this case, the RLC UM header may include, in an SI field, an indication that the RLC UM PDU contains a complete RLC UM SDU. On the receiving side, when an RLC UM PDU with no RLC UM SN is received at the RLC layer of the receiving device, the RLC layer delivers the RLC UM PDU to an upper layer (e.g., the PDCP layer) without performing RLC reassembly (e.g., without applying reassembly logic to the RLC UM PDU).

As indicated above, FIG. 3 is provided as an example. Other examples may differ from what is described with regard to FIG. 3.

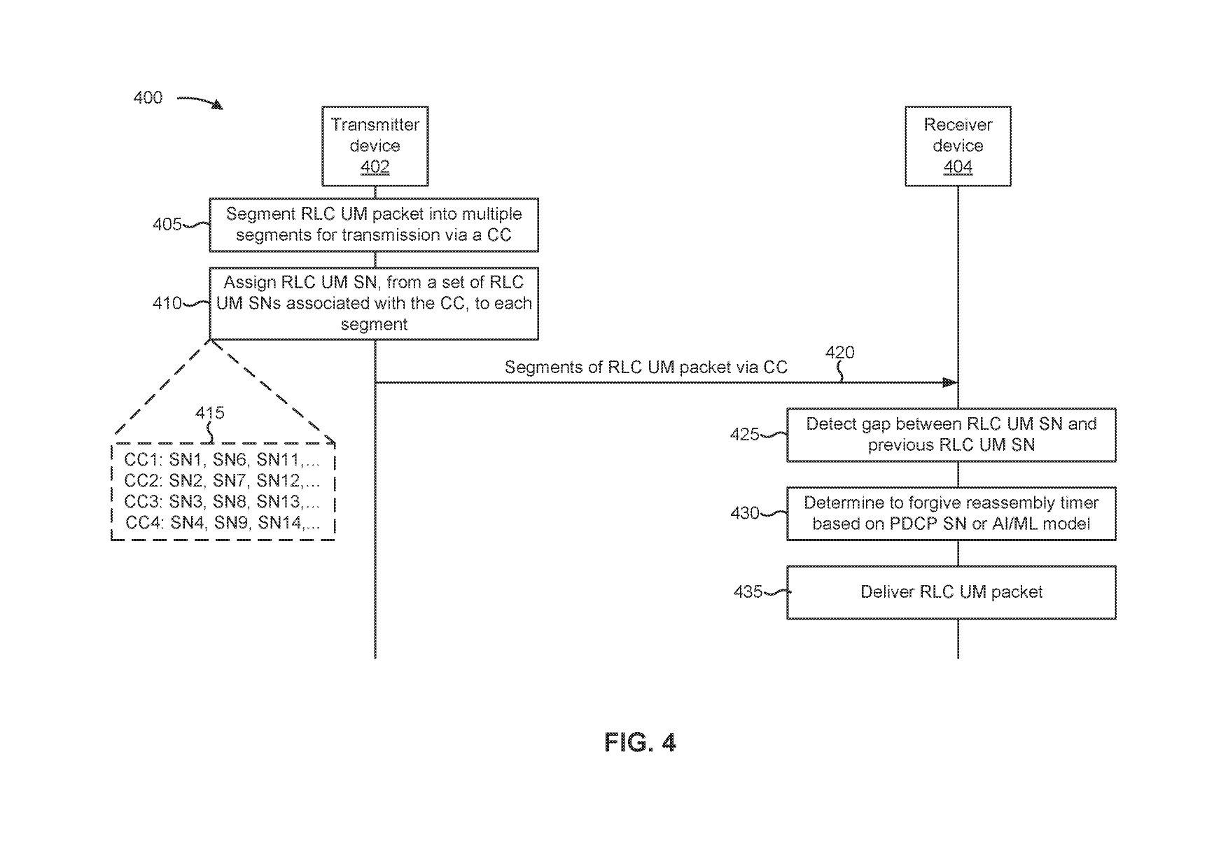

FIG. 4 is a diagram illustrating an example 400 associated with RLC UM SN continuity across CCs, in accordance with the present disclosure. As shown in FIG. 4, example 400 includes communication between a transmitter device 402 and a receiver device 404. In some aspects, transmitter device 402 and the receiver device 404 may be included in a wireless communication network, such as wireless communication network 100. In some aspects, the transmitter device 402 may be a network node (e.g., a network node 110), and the receiver device 404 may be a UE (e.g., a UE 120). In some aspects, the transmitter device 402 may be a UE (e.g., a UE 120), and the receiver device 404 may be a network node (e.g., a network node 110). In some aspects, the transmitter device 402 may be a first UE (e.g., a UE 120), and the receiver device 404 may be a second UE (e.g., a UE 120).

As shown in FIG. 4, and by reference number 405, the transmitter device 402 may segment an RLC UM packet into multiple segments for transmission via a CC of a plurality of CCs configured for transmitter device 402. “RLC UM packet” may refer to an RLC UM SDU and/or a data packet (e.g., an IP packet, a PDCP packet, or an SDAP packet) included or encapsulated in an RLC UM SDU. Accordingly, the RLC UM packet may be, or may be included in, an RLC UM SDU. In some aspects, the RLC UM SDU may include a data packet (e.g., an IP packet) associated with a QoS flow to be transmitted by the transmitter device 402 to the receiver device 404. For example, the data packet (e.g., the IP packet) to be transmitted by the transmitter device 402 may be received at an SDAP layer of the transmitter device 402 device as an SDAP SDU. The SDAP layer may encapsulate the SDAP SDU (e.g., the data packet) into an SDAP PDU (e.g., by adding an SDAP header to the SDAP SDU) and may pass the SDAP PDU to the PDCP layer of the transmitter device 402. The PDCP layer may receive the SDAP PDU as a PDCP SDU, may encapsulate the PDCP SDU into a PDCP PDU (e.g., by adding a PDCP header to the PDCP SDU), and may pass the PDCP PDU to the RLC layer of the transmitter device 402. The RLC layer of the transmitter device 402 may receive the PDCP PDU as an RLC SDU. For example, an RLC UM entity (e.g., an RLC entity configured for RLC UM), in the RLC layer of the transmitter device 402, may receive the PDCP PDU as an RLC UM SDU.

In some aspects, the RLC layer of the transmitter device 402 may determine to segment the RLC UM packet (e.g., the RLC UM SDU) into multiple segments based at least in part on a size of and/or an amount of space available in a MAC TB associated with a grant on a CC, of the plurality of CCs, for the transmitter device 402. For example, the RLC layer of the transmitter device 402 may determine to segment the RLC UM SDU into multiple RLC UM PDUs, each including a respective segment of the RLC UM SDU, in connection with a determination that the amount of space available in a MAC TB is insufficient for transmitting an RLC UM PDU containing the complete RLC UM SDU in the MAC TB. Accordingly, the RLC layer of the transmitter device 402 may segment the RLC UM SDU into multiple RLC UM PDUs that are to be transmitted in respective MAC TBs on the CC. In some aspects, the quantity of segments of the RLC UM packet may also be based at least in part on the size and/or available space in MAC TBs associated with one or more grants on the CC for the transmitter device 402. For example, quantity of segments may correspond to the quantity of MAC TBs used to transmit all of the bits of the RLC UM packet, in accordance with the size and/or available space in the granted MAC TBs.

In some aspects, each segment of the RLC UM packet may be included in a respective RLC UM PDU that is transmitted in a respective MAC TB on the CC. In some aspects, the RLC layer of the transmitter device 402 may segment the RLC UM packet (e.g., the RLC UM SDU) into at least a first RLC UM PDU (e.g., including a first segment of the RLC UM packet) and a second RLC UM PDU (e.g., including a second segment of the RLC UM packet). In some examples, the RLC UM packet may be segmented into only two RLC UM PDUs (e.g., the first RLC UM PDU and the second RLC UM PDU). In some other examples, the RLC UM packet may be segmented into more than two RLC UM PDUs (e.g., the first RLC UM PDUs, the second RLC UM PDU, and one or more other RLC UM PDUs).

As further shown in FIG. 4, and by reference number 410, the transmitter device 402 may assign an RLC UM SN, from a set of RLC UM SNs associated with the CC on which the segments of the RLC UM packet are to be transmitted, to each segment of the RLC UM packet. In some aspects, the RLC UM packet (e.g., the RLC UM SDU) may be segmented into multiple RLC UM PDUs (e.g., each including a respective segment), and the transmitter device 402 (e.g., the RLC layer of the transmitter device 402) may assign the RLC UM SN, from the set of RLC UM SNs associated with the CC, to a respective RLC UM header included in each RLC UM PDU of the multiple RLC UM PDUs.

In some aspects, each CC, of the plurality of CCs configured for the transmitter device 402 device, may be associated with a respective set of RLC UM SNs to be assigned to RLC segmentations (e.g., RLC UM PDUs including segments of an RLC UM SDU) to be transmitted on that CC. For each CC, the respective set of RLC UM SNs may start from a respective starting SN and may be separated by an offset. For example, as shown by reference number 415, a first set of RLC UM SNs associated with a first CC (CC1) includes SN1, SN6, SN11, and so on; a second set of RLC UM SNs associated with a second CC (CC2) includes SN2, SN7, SN12, and so on; a third set of RLC UM SNs associate with a third CC (CC3) includes SN3, SN8, SN13, and so on; and a fourth set of RLC UM SNs associated with a fourth CC (CC4) includes SN4, SN9, SN14, and so on. In some aspects, each set of RLC UM SNs (associated with a respective CC) may start from a different starting SN. Additionally, or alternatively, in some aspects, the offset between RLC UM SNs, in each set of RLC UM SNs, may be greater than or equal to the number of CCs in the plurality of CCs. In this way, the set of RLC UM SNs associated with each CC may be distinct with respect to the other sets of RLC UM SNs associated with the other CCs. For example, as shown by reference number 415, the sets of RLC UM SNs each have a different starting SN (e.g., SN1, SN2, SN3, and SN4), and the RLC UM SNs, in each set of RLC UM SNs, are separated by an offset of 5. In some aspects, the starting SN in each set of RLC UM SNs (e.g., associated with a respective CC) may be less than a next SN after a starting SN (e.g., separated from the starting SN by the offset) in each other set of RLC UM SNs. In this way, assigning an RLC UM SN from one set of RLC UM SNs will not result in all subsequent RLC UM SNs from another set of RLC UM SNs being discarded as OOW. In some aspects, the offset between the RLC UM SNs in each set of RLC UM SNs may be a fixed offset (e.g., a fixed offset greater than or equal to the number of CCs). In some other aspects, the offset between the RLC UM SNs in each set of RLC UM SNs may be a variable offset (e.g., different offsets may separate different RLC UM SNs within a set of RLC UM SNs and/or different offsets may separate RLC UM SNs in different sets of RLC UM SNs).

In some aspects, for every segmentation on any CC, of the plurality of CCs, the transmitter device 402 (e.g., the RLC layer of the transmitter device 402) may assign the RLC UM SN to the segmented RLC UM PDUs in accordance with the set of RLC UM SNs associated with the CC. Accordingly, RLC UM SNs assigned for segmented RLC UM packets transmitted on the CC may jump by the offset value. In this way, the RLC UM SNs may be assigned using real-time coordination of segmentation only on a given CC (e.g., without real-time coordination of segmentations between different CCs). As segmentation happens to the last RLC UM PDU in a current MC TB, at maximum there may be only one new RLC UM SN based segment in any MAC TB.

In some aspects, the transmitter device 402 (e.g., the RLC layer of the transmitter device 402) may coordinate across the plurality of CCs at a reoccurring time interval to synchronize the respective set of RLC UM SNs for each CC of the plurality of CCs with respect to a highest RLC UM SN previously assigned across the plurality of CCs. For example, after each occurrence of the time interval, the transmitter device 402 may coordinate across the CCs to synchronize the respective sets of RLC UM SNs for associated with the CCs such that a next RLC UM SN value to be selected in each respective set of RLC UM SNs is higher than the highest RLC UM previously assigned (e.g., in the previous occurrence of the time interval) across all of the plurality of CCs. That is, the transmitter device 402 (e.g., the RLC layer) may cause each set of RLC UM SNs to jump to a value higher than the highest RLC UM previously assigned across all of the CCs, even if the jump to the value higher than the highest RLC UM previously assigned across all of the CCs skips over an RLC UM SN in a given set of RLC UM SNs that has not been assigned in the CC associated with that set of RLC UM SNs. In some aspects, after each occurrence of the time interval, the transmitter device 402 (e.g., the RLC layer) may synchronize the respective sets of RLC UM SNs associated with the CCs by determining whether an RLC UM SN was assigned for any CC in the previous time interval, and causing each of the respective sets of RLC UM SNs to advance to next RLC UM SN value if an RLC UM SN was assigned for any CC in the previous time interval. For instance, in the example shown by reference number 415, if a first RL UM SN value (e.g., SN1, SN2, SN3, or SN4) is assigned for any of CC1, CC2, CC3, or CC4 in a first time interval, the transmitter device 402 may cause the respective set of RLC UM SNs for each of CC1, CC2, CC3, and CC4 to advance to a next RL UM SN value (e.g., SN6, SN7, SN8, and SN9) to be used for an RLC UM SN assigned in a second time interval. In some aspects, the reoccurring time interval may be equal to, or otherwise associated with, a time duration of an RLC reassembly timer (T reassembly). For example, the transmitter device 402 may perform the coordination across the CCs to synchronize the respective set of RLC UM SNs for each CC with respect to a highest RLC UM SN previously assigned across the CCs at least once per T reassembly _{.} In some aspects, the reoccurring time interval may be a slot or another scheduling time interval. In such example, the transmitter device 402 may perform the coordination across the CCs to synchronize the respective set of RLC UM SNs for each CC with respect to a highest RLC UM SN previously assigned across the CCs after each slot (or after each occurrence of another scheduling time interval).

In some aspects, in the case in which the RLC UM packet (e.g., the RLC UM SDU) is segmented into the first RLC UM PDU and the second RLC UM PDU for transmission on a CC of the plurality of CCs, the transmitter device 402 (e.g., the RLC layer) may assign an RLC UM SN, from the set of RLC UM SNs associated with the CC, to a first RLC UM header of the first RLC UM PDU, and the transmitter device 402 may assign the RLC UM SN, from the set of RLC UM SNs associated with the CC, to a second RLC UM header of the second RLC UM PDU. The assigned RLC UM SN may be used to indicate that the first RLC UM PDU and the second RLC UM PDU are (or include) segments of the RLC UM packet. Accordingly, the same RLC UM SN, from the set of RLC UM SNs associated with the CC, may be assigned to the first RLC UM header of the first RLC UM PDU and the second RLC UM header of the second PDU. In some aspects, the RLC UM SN, from the set of RLC UM SNs associated with the CC, assigned to the first RLC UM header of the first RLC UM PDU and the second RLC UM header of the second PDU may be greater than a highest RLC UM SN previously assigned (e.g., in a previous time interval) across all of the plurality of CCs.

As further shown in FIG. 4, and by reference number 420, the transmitter device 402 may transmit, and the receiver device 404 may receive, the segments of the RLC UM packet via the CC. In some aspects, the segments of the RLC UM packet (e.g., the RLC UM SDU) may include (or be included in) multiple RLC UM PDUs. The transmitter device 402 may transmit the multiple RLC UM PDUs (e.g., the segments) in respective TBs via the CC. Each RLC UM PDU, of the multiple RLC UM PDUs, may include a respective RLC UM header that indicates the RLC UM SN from the set of RLC UM SNs associated with the CC. For example, the transmitter device 402 may transmit the first RLC UM PDU (e.g., including a first segment of the RLC UM packet) and the second RLC UM PDU (e.g., including a second segment of the RLC UM packet) in respective TBs via the CC. The first RLC UM PDU may include a first RLC UM header indicating the SN from the set of SNs associated with the CC. The second RLC UM PDU may include a second RLC UM header indicating the SN from the set of SNs associated with the CC.

In some aspects, the RLC UM header of each RLC UM PDU including a segment of the RLC UM packet may include an indication (e.g., in an SN field) of the SN from the set of SNs associated with the CC and an indication in an SI field. The indication in the SI field may indicate that the RLC UM PDU contains a first segment of an RLC UM SDU (e.g., the RLC UM packet), a middle segment of the RLC UM SDU, or a last segments of the RLC UM SDU. In some aspects, the RLC UM header of an RLC UM PDU that contains a middle segment or the last segment of the RLC UM SDU may also include an indication of a segmentation offset (SO) (e.g., in an SO field). The SO may indicate a starting location for the segment of the RLC UM SDU included in the payload of the RLC UM PDU. The RLC UM header of an RLC UM PDU that contains the first segment of the RLC UM SUD may not include an indication of an SO.

In some aspects, by indicating the RLC UM SN for segments transmitted via CCs of the plurality of CCs, from the respective sets of RLC UM SNs associated with the CCs, the transmitter device 402 may be prevented from indicating duplicated RLC UM SNs for segments of RLC UM packets transmitted via different CCs (e.g., transmitted in parallel via different CCs), thus preventing packets from being dropped at the receiver device 404 due to being assigned duplicate RLC UM SNs. Furthermore, by coordinating across the CCs at the reoccurring time interval to synchronize a jump in each of the respective sets of RLC UM SNs associated with the CCs with respect to a highest RLC UM SN previously assigned in any of the CCs, the transmitter device 402 may be prevented from indicating RLC UM SNs that fall outside of (e.g., below) the reassembly window at the receiver device 404, thus further preventing packets from being discarded at the receiver device 404.

As further shown in FIG. 4, and by reference number 425, the receiver device 404, in connection with receiving the segments of the RLC UM packet, may detect a gap between the RLC UM SN associated with RLC UM packet and a previous RL UM SN associated with a previously received RLC UM packet. For example, the RLC layer may determine that the RLC UM SN indicated in the RLC UM headers of the RLC UM PDUs including the segments of the RLC UM packet (e.g., the RLC UM SDU) is separated from the previous RL UM SN associated with the previously received RLC UM packet by a gap (e.g., by a difference in SNs greater than one). The previously received RLC UM packet may be most recent previously received UM packet delivered from the RLC layer of the receiver device 404 to the PDCP layer of the receiver device 404. For example, the previously received RLC UM packet may be most recent previously received segmented UM packet reassembled by the RLC layer and delivered to the PDCP layer of the receiver device 404. Accordingly, the RLC layer may have adjusted a reassembly window in accordance with the previous RLC UM SN associated with the previously received RLC UM packet such that an expected next RLC UM SN is a subsequent SN to the previous RLC UM SN. In this case, the receiver device 404 (e.g., the RLC layer of the receiver device 404) may determine that the RLC UM SN associated with the received RLC UM packet (e.g., indicated in the RLC UM headers of the RLC UM PDUs including the segments of the RLC UM packet) is not the expected next RLC UM SN in connection with detecting the gap between the RLC UM SN and the previous RLC UM SN.

In some aspects, a reassembly timer (T reassmbly) may be associated with the gap between the RLC UM SN and the previous RLC UM SN. For example, the receiver device 404 may be triggered to start the reassembly timer (T reassmbly) in connection with detecting the gap between the RLC UM SN and the previous RLC UM SN (e.g., in connection with determining that the RLC UM SN is not the expected next RLC UM SN).

As further shown in FIG. 4, and by reference number 430, the receiver device 404 may forgive a reassembly timer (T reassmbly) based at least in part on a PDCP SN included in the RLC UM packet or based at least in part on an AI/ML model. That is, the receiver device 404 (e.g., the RLC layer of the receiver device 404) may determine not to start the reassembly timer (T reassmbly) even though there is a gap between the RLC UM SN associated with the RLC UM packet and the previous RLC UM SN associated with the previously received RLC UM packet (e.g., even though the RLC UM SN associated with the RLC UM packet is not the expected next RLC UM SN).

In some aspects, the receiver device 404 may determine to forgive the reassembly timer (T reassmbly) (e.g., determine not to start T reassmbly even though the RLC UM SN is not the expected next RLC UM SN) based at least in part on the PDCP SN included in the RLC UM packet. The RLC UM packet (e.g., the RLC UM SDU) may include a PDCP header that indicates a PDCP SN. The PDCP SN may be used for reordering of packets received at the PDCP layer. The PDCP SN may be different from the RLC UM SN (e.g., which may be used for RLC reassembly at the RLC layer). In some aspects, the receiver device 404 (e.g., the RLC layer) may forgive the reassembly timer (T reassmbly) in connection with the RLC UM packet (e.g., the RLC UM PDUs including the segments of the RLC UM packet) being received via a CC, of the plurality of CCs, different from a CC on which the previously received RLC UM packet was received, and in connection with the PDCP SN included in the RLC UM packet being a next expected PDCP SN. In this way, the receiver device 404 may forgive the reassembly timer (T reassmbly) when there is a jump in the RLC sequence number between the previous RLC UM SN and the current RLC UM SN due to the previously received RLC UM packet and the current RLC UM packet being received via different CCs (e.g., in accordance with the previous and current RLC UM SNs being assigned from the respective sets of RLC UM SNs associated with the different CCs as discussed in connection with reference number 410) and the PDCP SNs associated with the previously received RLC UM packet and the current RLC UM packet are in-sequence.

In some aspects, the transmitter device 402 may forgive the reassembly timer (T reassmbly) (e.g., determine not to start T reassmbly even though the RLC UM SN is not the expected next RLC UM SN) in connection with detection, by an AI/ML model, that the gap between the RLC UM SN and the previous RLC UM SN corresponds to an RLC UM SN jump across different CCs of a plurality of CCs. For example, the AI/ML model may detect that the gap between the RLC UM SN and the previous RLC UM SN corresponds to the RLC UM SN jump across different CCs based at least in part on a scheduling pattern and/or latency requirements of a QoS flow mapped to a radio bearer associated with the RLC UM packet. In some aspects, the AI/ML may be hosted/deployed at the receiver device 404. In some aspects, the AI/ML model may be trained based at least in part on varying scheduling patterns. For example, the AI/ML model may be trained using statistics based training, reinforced learning, and/or other ML training techniques based at least in part on varying scheduling patterns and/or other training data. In some aspects, the AI/ML model may be training based at least in part a plurality of receiver devices (e.g., a plurality of UEs) using federated learning. For example, the AI/ML may be trained at a server level using federated learning based at least in part on updates to the AI/ML model received from a plurality of UEs in connection with training operations performed by the plurality of UEs. In some aspects, the receiver device 404, in connection with detecting the gap between the RLC UM SN and the previous RLC UM SN (e.g., determining that the RLC UM SN is not the expected next RLC UM SN), may use the AI/ML model to detect whether the gap between the RLC UM SN and the previous RLC UM SN corresponds to an RLC UM SN jump across different CCs. In this case, the receiver device 404 may forgive the reassembly timer (T reassmbly) when the AI/ML model detects that the gap between the RLC UM SN and the previous RLC UM SN corresponds to an RLC UM SN jump across different CCs.

As further show in FIG. 4, and by reference number 435, the receiver device 404 may deliver the RLC UM packet (e.g., to an upper layer). In some aspects, in a case in which the receiver device 404 detects the gap between the RLC UM SN and the previous RLC UM SN, the receiver device 404 (e.g., the RLC layer of the receiver device 404) may deliver the RLC UM packet without starting the reassembly timer (T reassmbly) (e.g., and without waiting for expiry of T reassmbly) in connection with forgiving the reassembly timer (T reassmbly). That is, if the receiver device 404 forgives the reassembly timer (T reassmbly), the receiver device 404 (e.g., the RLC layer of the receiver device 404) may deliver the RLC UM packet when all segments of the RLC UM packet are received without starting the reassembly timer (T reassmbly) (e.g., and without waiting for expiry of T reassmbly). In some aspects, delivering the RLC UM packet may include delivering the RLC UM packet from the RLC layer of the receiver device 404 to the PDCP layer of the receiver device 404. For example, delivering the RLC UM packet may include delivering the RLC UM SDU to the PDCP layer (e.g., as a PDCP PDU). Additionally, or alternatively, delivering the RLC UM packet may include delivering data included in the RLC UM packet (e.g., a data packet, such as an IP packet, included in the RLC UM SDU) to an application executing on the receiver device 404.

In some aspects, the receiver device 404 may deliver the RLC UM packet without starting the reassembly timer (T reassmbly) (e.g., even though there is a gap between the RLC UM SN and the previous RLC UM SN) in connection with the segments of the RLC UM packet being received via a CC, of a plurality of CCs, different from a CC via which the previously received RLC UM packet was received, and in connection with a PDCP SN included in the RLC UM packet being a next expected PDCP SN. For example, the receiver device 404 may deliver the RLC UM packet without starting the reassembly timer (T reassmbly) when all of the segments of the RLC UM packet are received (e.g., at the RLC layer of the receiver device 404) and in connection with a determination the segments of the RLC UM packet being received via a CC, of a plurality of CCs, different from a CC via which the previously received RLC UM packet was received, and a determination that the PDCP SN included in the RLC UM packet being a next expected PDCP SN.

In some aspects, the receiver device 404 may deliver the RLC UM packet without starting the reassembly timer (T reassmbly) (e.g., even though there is a gap between the RLC UM SN and the previous RLC UM SN) in connection with detection, using AI/ML model, that the gap between the RLC UM SN and the previous RLC UM SN corresponds to an RLC UM SN jump across different CCs of the plurality of CCs. For example, the receiver device 404 may deliver the RLC UM packet without starting the reassembly timer (T reassmbly) when all of the segments of the RLC UM packet are received (e.g., at the RLC layer of the receiver device 404) and in connection with the AI/ML model detecting that the gap between the RLC UM SN and the previous RLC UM SN corresponds to an RLC UM SN jump across different CCs.

In some aspects, by enabling the receiver device 404 to forgive the reassembly timer (T reassmbly) and to deliver the RLC UM packet without starting the reassembly timer (T reassmbly), when the RLC UM SN jumps across CCs due to scheduler/encoding restrictions on the transmitter device 402 side, the receiver device 404 is able to provide enhanced latency and throughput performance for traffic received at the receiver device 404. This may reduce the impact of jumps in RLC UM SN to application traffic level, and reduce the impact to the user experience, in terms of latency and throughput.

As indicated above, FIG. 4 is provided as an example. Other examples may differ from what is described with respect to FIG. 4.

FIG. 5 is a diagram illustrating an example process 500 performed, for example, at a transmitter device or an apparatus of a transmitter device, in accordance with the present disclosure. Example process 500 is an example where the apparatus or the transmitter device (e.g., transmitter device 402) performs operations associated with RLC UM SN continuity across CCs.

As shown in FIG. 5, in some aspects, process 500 may include segmenting an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one (block 510). For example, the transmitter device (e.g., using communication manager 806, depicted in FIG. 8) may segment an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one, as described above.

As further shown in FIG. 5, in some aspects, process 500 may include transmitting the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC (block 520). For example, the transmitter device (e.g., using transmission component 804 and/or communication manager 806, depicted in FIG. 8) may transmit the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC, as described above.

Process 500 may include additional aspects, such as any single aspect or any combination of aspects described below and/or in connection with one or more other processes described elsewhere herein.

In a first aspect, the respective starting SN in the respective set of RLC UM SNs for each CC of the plurality of CCs is different from the respective starting SN in the respective set of RLC UM SNs for each other CC of the plurality of CCs.

In a second aspect, alone or in combination with the first aspect, the respective starting SN in the respective set of RLC UM SNs for each CC of the plurality of CCs is less than a respective next SN, separated from the respective starting SN by the offset, in the respective set of RLC UM SNs for each other CC of the plurality of CCs.

In a third aspect, alone or in combination with one or more of the first and second aspects, the offset is a fixed offset.

In a fourth aspect, alone or in combination with one or more of the first through third aspects, the offset is greater or equal to than a number of CCs in the plurality of CCs.

In a fifth aspect, alone or in combination with one or more of the first through fourth aspects, process 500 includes coordinating across the plurality of CCs at a reoccurring time interval to synchronize the respective set of RLC UM SNs for each CC of the plurality of CCs with respect to a highest RLC UM SN previously assigned across the plurality of CCs.

In a sixth aspect, alone or in combination with one or more of the first through fifth aspects, the reoccurring time interval is a slot.

In a seventh aspect, alone or in combination with one or more of the first through sixth aspects, the reoccurring time interval is associated with an RLC reassembly timer.

In an eighth aspect, alone or in combination with one or more of the first through seventh aspects, coordinating across the plurality of CCs includes synchronizing the respective set of RLC UM SNs for each CC of the plurality of CCs with respect to the highest RLC UM SN previously assigned across the plurality of CCs in connection with an RLC UM SN being assigned to an RLC UM header of an RLC UM PDU transmitted via any CC of the plurality of CCs in a most recent occurrence of the reoccurring time interval.

In a ninth aspect, alone or in combination with one or more of the first through eighth aspects, coordinating across the plurality of CCs includes synchronizing the respective set of RLC UM SNs for each CC of the plurality of CCs such that, for each CC of the plurality of CCs, a next RLC UM SN to be assigned from the respective set of RLC UM SNs is greater than the highest RLC UM SN previously assigned across the plurality of CCs.

In a tenth aspect, alone or in combination with one or more of the first through ninth aspects, the RLC UM SN from the respective set of RLC UM SNs associated with the CC is greater than a highest RLC UM SN previously assigned across the plurality of CCs.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a receiver device or an apparatus of a receiver device, in accordance with the present disclosure. Example process 600 is an example where the apparatus or the receiver device (e.g., receiver device 404) performs operations associated with RLC UM SN continuity across CCs.

As shown in FIG. 6, in some aspects, process 600 may include receiving segments of an RLC UM packet associated with an RLC UM SN (block 610). For example, the receiver device (e.g., using reception component 902 and/or communication manager 906, depicted in FIG. 9) may receive segments of an RLC UM packet associated with an RLC UM SN, as described above.

As further shown in FIG. 6, in some aspects, process 600 may include delivering the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN (block 620). For example, the receiver device (e.g., using communication manager 906, depicted in FIG. 9) may deliver the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN, as described above.

Process 600 may include additional aspects, such as any single aspect or any combination of aspects described below and/or in connection with one or more other processes described elsewhere herein.

In a first aspect, the previously received RLC UM packet is a most recent previously received RLC UM packet.

In a second aspect, alone or in combination with the first aspect, delivering the RLC UM packet includes delivering the RLC UM packet within starting a reassembly timer further in connection with receiving all of a plurality of RLC UM PDUs associated with the RLC UM SN.

In a third aspect, alone or in combination with one or more of the first and second aspects, process 600 includes determining that the RLC UM SN is not an expected next RLC UM SN in connection with detecting the gap between the RLC UM SN and the previous RLC UM SN.

In a fourth aspect, alone or in combination with one or more of the first through third aspects, delivering the RLC UM packet includes delivering the RLC UM packet from an RLC layer of the receiver device to a PDCP layer of the receiver device.

In a fifth aspect, alone or in combination with one or more of the first through fourth aspects, delivering the RLC UM packet includes delivering data included in the RLC UM packet to an application executing on the receiver device.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a receiver device or an apparatus of a receiver device, in accordance with the present disclosure. Example process 700 is an example where the apparatus or the receiver device (e.g., receiver device 404) performs operations associated with RLC UM SN continuity across CCs.

As shown in FIG. 7, in some aspects, process 700 may include receiving segments of an RLC UM packet associated with an RLC UM SN (block 710). For example, the receiver device (e.g., using reception component 902 and/or communication manager 906, depicted in FIG. 9) may receive segments of an RLC UM packet associated with an RLC UM SN, as described above.

As further shown in FIG. 7, in some aspects, process 700 may include delivering the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs (block 720). For example, the receiver device (e.g., using communication manager 906, depicted in FIG. 9) may deliver the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs, as described above.

Process 700 may include additional aspects, such as any single aspect or any combination of aspects described below and/or in connection with one or more other processes described elsewhere herein.

In a first aspect, the AI/ML model detects that the gap between the RLC UM SN and the previous RLC UM SN corresponds to the RLC UM SN jump across the different CCs based at least in part on at least one of a scheduling pattern or latency requirements of a QoS flow mapped to a radio bearer associated with the RLC UM packet.

In a second aspect, alone or in combination with the first aspect, the AI/ML model is trained based at least in part on varying scheduling patterns.

In a third aspect, alone or in combination with one or more of the first and second aspects, the AI/ML model is trained based at least in part on a plurality of receiver devices using federated learning.

In a fourth aspect, alone or in combination with one or more of the first through third aspects, delivering the RLC UM packet includes delivering the RLC UM packet within starting a reassembly timer further in connection with receiving all of a plurality of RLC UM PDUs associated with the RLC UM SN.

In a fifth aspect, alone or in combination with one or more of the first through fourth aspects, delivering the RLC UM packet includes delivering the RLC UM packet from an RLC layer of the receiver device to a PDCP layer of the receiver device.

In a sixth aspect, alone or in combination with one or more of the first through fifth aspects, delivering the RLC UM packet includes delivering data included in the RLC UM packet to an application executing on the receiver device.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a transmitter device, or a transmitter device may include the apparatus 800. In some aspects, the apparatus 800 may be a network node, or a network node may include the apparatus 800. In some aspects, the apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 or 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 or 140 described in connection with FIG. 1) of the transmitter device.

In some aspects, the apparatus 800 may be configured to perform one or more operations described herein in connection with FIGS. 3-4. Additionally, or alternatively, the apparatus 800 may be configured to perform one or more processes described herein, such as process 500 of FIG. 5, or a combination thereof. In some aspects, the apparatus 800 and/or one or more components shown in FIG. 8 may include one or more components of the network node or the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node or the UE described above in connection with FIG. 1, such as a radio, one or more RF chains, one or more transceivers, or one or more modems, each of which may in turn be coupled with one or more antennas of the transmitter device.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node or the UE described above in connection with FIG. 1, such as a radio, one or more RF chains, one or more transceivers, or one or more modems, each of which may in turn be coupled with one or more antennas of the network node or the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may segment an RLC UM packet into a first RLC UM PDU and a second RLC UM PDU for transmission via a CC of a plurality of CCs, wherein each CC, of the plurality of CCs, is associated with a respective set of RLC UM SNs starting from a respective starting SN and separated by an offset greater than one. The transmission component 804 may transmit the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

The communication manager 806 may coordinate across the plurality of CCs at a reoccurring time interval to synchronize the respective set of RLC UM SNs for each CC of the plurality of CCs with respect to a highest RLC UM SN previously assigned across the plurality of CCs.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a receiver device, or a receiver device may include the apparatus 900. In some aspects, the apparatus 900 may be a UE, or a UE may include the apparatus 900. In some aspects, the apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 or 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or 145 described in connection with FIG. 1) of the receiver device.

In some aspects, the apparatus 900 may be configured to perform one or more operations described herein in connection with FIGS. 3-4. Additionally, or alternatively, the apparatus 900 may be configured to perform one or more processes described herein, such as process 600 of FIG. 6, process 700 of FIG. 7, or a combination thereof. In some aspects, the apparatus 900 and/or one or more components shown in FIG. 9 may include one or more components of the UE or the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE or the network node described above in connection with FIG. 1, such as a radio, one or more RF chains, one or more transceivers, or one or more modems, each of which may in turn be coupled with one or more antennas of the receiver device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE or the network node described above in connection with FIG. 1, such as a radio, one or more RF chains, one or more transceivers, or one or more modems, each of which may in turn be coupled with one or more antennas of the UE or the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some aspects, the reception component 902 may receive segments of an RLC UM packet associated with an RLC UM SN. The communication manager 906 may deliver the RLC UM packet without starting a reassembly timer associated with a gap between the RLC UM SN and a previous RLC UM SN, associated with a previously received RLC UM packet, in connection with the segments of the RLC UM packet being received via a CC, of a plurality of CCs, different from a CC via which the previously received RLC UM packet was received, and in connection with a PDCP SN included in the RLC UM packet being a next expected PDCP SN.

The communication manager 906 may determine that the RLC UM SN is not an expected next RLC UM SN in connection with detecting the gap between the RLC UM SN and the previous RLC UM SN.

In some aspects, the reception component 902 may receive segments of an RLC UM packet associated with an RLC UM SN. The communication manager 906 may deliver the RLC UM packet without starting a reassembly timer in connection with detection, using an AI/ML model, that a gap between the RLC UM SN and a previous RLC UM SN, associated with a previously received RLC UM packet, corresponds to an RLC UM SN jump across different CCs of a plurality of CCs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a transmitter device, comprising: segmenting a radio link control (RLC) unacknowledged mode (UM) packet into a first RLC UM protocol data unit (PDU) and a second RLC UM PDU for transmission via a carrier component (CC) of a plurality of CCs, wherein each CC, of the plurality of CCs, is associated with a respective set of RLC UM sequence numbers (SNs) starting from a respective starting SN and separated by an offset greater than one; and transmitting the first RLC UM PDU and the second RLC UM PDU via the CC, the first RLC UM PDU including a first RLC UM header indicating an RLC UM SN from the respective set of RLC UM SNs associated with the CC, and the second RLC UM PDU including a second RLC UM header indicating the RLC UM SN from the respective set of RLC UM SNs associated with the CC.

Aspect 2: The method of Aspect 1, wherein the respective starting SN in the respective set of RLC UM SNs for each CC of the plurality of CCs is different from the respective starting SN in the respective set of RLC UM SNs for each other CC of the plurality of CCs.

Aspect 3: The method of any of Aspects 1-2, wherein the respective starting SN in the respective set of RLC UM SNs for each CC of the plurality of CCs is less than a respective next SN, separated from the respective starting SN by the offset, in the respective set of RLC UM SNs for each other CC of the plurality of CCs.

Aspect 4: The method of any of Aspects 1-3, wherein the offset is a fixed offset.

Aspect 5: The method of any of Aspects 1-4, wherein the offset is greater or equal to than a number of CCs in the plurality of CCs.

Aspect 6: The method of any of Aspects 1-5, further comprising: coordinating across the plurality of CCs at a reoccurring time interval to synchronize the respective set of RLC UM SNs for each CC of the plurality of CCs with respect to a highest RLC UM SN previously assigned across the plurality of CCs.

Aspect 7: The method of Aspect 6, wherein the reoccurring time interval is a slot.

Aspect 8: The method of Aspect 6, wherein the reoccurring time interval is associated with an RLC reassembly timer.

Aspect 9: The method of any of Aspects 6-8, wherein coordinating across the plurality of CCs comprises: synchronizing the respective set of RLC UM SNs for each CC of the plurality of CCs with respect to the highest RLC UM SN previously assigned across the plurality of CCs in connection with an RLC UM SN being assigned to an RLC UM header of an RLC UM PDU transmitted via any CC of the plurality of CCs in a most recent occurrence of the reoccurring time interval.

Aspect 10: The method of any of Aspects 6-9, wherein coordinating across the plurality of CCs comprises: synchronizing the respective set of RLC UM SNs for each CC of the plurality of CCs such that, for each CC of the plurality of CCs, a next RLC UM SN to be assigned from the respective set of RLC UM SNs is greater than the highest RLC UM SN previously assigned across the plurality of CCs.

Aspect 11: The method of any of Aspects 1-10, wherein the RLC UM SN from the respective set of RLC UM SNs associated with the CC is greater than a highest RLC UM SN previously assigned across the plurality of CCs.

Aspect 12: A method of wireless communication performed by a receiver device, comprising: receiving segments of a radio link control (RLC) unacknowledged mode (UM) packet associated with an RLC UM sequence number (SN); and delivering the RLC UM packet without starting a reassembly timer associated with a gap between the RLC UM SN and a previous RLC UM SN, associated with a previously received RLC UM packet, in connection with the segments of the RLC UM packet being received via a component carrier (CC), of a plurality of CCs, different from a CC via which the previously received RLC UM packet was received, and in connection with a packet data convergence protocol (PDCP) SN included in the RLC UM packet being a next expected PDCP SN.

Aspect 13: The method of Aspect 12, wherein the previously received RLC UM packet is a most recent previously received RLC UM packet.

Aspect 14: The method of any of Aspects 12-13, wherein delivering the RLC UM packet comprises: delivering the RLC UM packet within starting a reassembly timer further in connection with receiving all of a plurality of RLC UM protocol data units (PDUs) associated with the RLC UM SN.

Aspect 15: The method of any of Aspects 12-14, further comprising: determining that the RLC UM SN is not an expected next RLC UM SN in connection with detecting the gap between the RLC UM SN and the previous RLC UM SN.

Aspect 16: The method of any of Aspects 12-15, wherein delivering the RLC UM packet comprises: delivering the RLC UM packet from an RLC layer of the receiver device to a PDCP layer of the receiver device.

Aspect 17: The method of any of Aspects 12-15, wherein delivering the RLC UM packet comprises: delivering data included in the RLC UM packet to an application executing on the receiver device.

Aspect 18: A method of wireless communication performed by a receiver device, comprising: receiving segments of a radio link control (RLC) unacknowledged mode (UM) packet associated with an RLC UM sequence number (SN); and delivering the RLC UM packet without starting a reassembly timer in connection with detection, using an artificial intelligence (AI) or machine learning (ML) (AI/ML) model, that a gap between the RLC UM SN and a previous RLC UM SN, associated with a previously received RLC UM packet, corresponds to an RLC UM SN jump across different component carriers (CCs) of a plurality of CCs.

Aspect 19: The method of Aspect 18, wherein the AI/ML model detects that the gap between the RLC UM SN and the previous RLC UM SN corresponds to the RLC UM SN jump across the different CCs based at least in part on at least one of a scheduling pattern or latency requirements of a quality of service (QoS) flow mapped to a radio bearer associated with the RLC UM packet.

Aspect 20: The method of any of Aspects 18-19, wherein the AI/ML model is trained based at least in part on varying scheduling patterns.

Aspect 21: The method of any of Aspects 18-20, wherein the AI/ML model is trained based at least in part on a plurality of receiver devices using federated learning.

Aspect 22: The method of any of Aspects 18-21, wherein delivering the RLC UM packet comprises: delivering the RLC UM packet within starting a reassembly timer further in connection with receiving all of a plurality of RLC UM protocol data units (PDUs) associated with the RLC UM SN.

Aspect 23: The method of any of Aspects 18-22, wherein delivering the RLC UM packet comprises: delivering the RLC UM packet from an RLC layer of the receiver device to a PDCP layer of the receiver device.

Aspect 24: The method of any of Aspects 18-22, wherein delivering the RLC UM packet comprises: delivering data included in the RLC UM packet to an application executing on the receiver device.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter device for wireless communication, comprising:
one or more memories; and
one or more processors coupled to the one or more memories, the one or more processors individually or collectively configured to:
segment a radio link control (RLC) unacknowledged mode (UM) packet into a first RLC UM protocol data unit (PDU) and a second RLC UM PDU for transmission via a carrier component (CC) of a plurality of CCs, wherein each CC, of the plurality of CCs, is associated with a respective set of RLC UM sequence numbers (SNs) starting from a respective starting SN and separated by an offset greater than one; and
transmit the first RLC UM PDU and the second RLC UM PDU via the CC,
the first RLC UM PDU including a first RLC UM header indicating an RLC UM SN from the respective set of RLC UM SNs associated with the CC, and
the second RLC UM PDU including a second RLC UM header indicating the RLC UM SN from the respective set of RLC UM SNs associated with the CC.

2. The transmitter device of claim 1, wherein the respective starting SN in the respective set of RLC UM SNs for each CC of the plurality of CCs is different from the respective starting SN in the respective set of RLC UM SNs for each other CC of the plurality of CCs.

3. The transmitter device of claim 1, wherein the respective starting SN in the respective set of RLC UM SNs for each CC of the plurality of CCs is less than a respective next SN, separated from the respective starting SN by the offset, in the respective set of RLC UM SNs for each other CC of the plurality of CCs.

4. The transmitter device of claim 1, wherein the offset is a fixed offset.

5. The transmitter device of claim 1, wherein the offset is greater than or equal to a number of CCs in the plurality of CCs.

6. The transmitter device of claim 1, wherein the one or more processors are individually or collectively configured to:
coordinate across the plurality of CCs at a reoccurring time interval to synchronize the respective set of RLC UM SNs for each CC of the plurality of CCs with respect to a highest RLC UM SN previously assigned across the plurality of CCs.

7. The transmitter device of claim 6, wherein the reoccurring time interval is a slot.

8. The transmitter device of claim 6, wherein the reoccurring time interval is associated with an RLC reassembly timer.

9. The transmitter device of claim 6, wherein the one or more processors, to cause the transmitter device to coordinate across the plurality of CCs, are individually or collectively configured to:
synchronize the respective set of RLC UM SNs for each CC of the plurality of CCs with respect to the highest RLC UM SN previously assigned across the plurality of CCs in connection with an RLC UM SN being assigned to an RLC UM header of an RLC UM PDU transmitted via any CC of the plurality of CCs in a most recent occurrence of the reoccurring time interval.

10. The transmitter device of claim 6, wherein the one or more processors, to cause the transmitter device to coordinate across the plurality of CCs, are individually or collectively configured to:
synchronize the respective set of RLC UM SNs for each CC of the plurality of CCs such that, for each CC of the plurality of CCs, a next RLC UM SN to be assigned from the respective set of RLC UM SNs is greater than the highest RLC UM SN previously assigned across the plurality of CCs.

11. The transmitter device of claim 1, wherein the RLC UM SN from the respective set of RLC UM SNs associated with the CC is greater than a highest RLC UM SN previously assigned across the plurality of CCs.

12. A receiver device for wireless communication, comprising:
one or more memories; and
one or more processors coupled to the one or more memories, the one or more processors individually or collectively configured to:
receive segments of a radio link control (RLC) unacknowledged mode (UM) packet associated with an RLC UM sequence number (SN); and
deliver the RLC UM packet without starting a reassembly timer associated with a gap between the RLC UM SN and a previous RLC UM SN, associated with a previously received RLC UM packet, in connection with the segments of the RLC UM packet being received via a component carrier (CC), of a plurality of CCs, different from a CC via which the previously received RLC UM packet was received, and in connection with a packet data convergence protocol (PDCP) SN included in the RLC UM packet being a next expected PDCP SN.

13. The receiver device of claim 12, wherein the previously received RLC UM packet is a most recent previously received RLC UM packet.

14. The receiver device of claim 12, wherein the one or more processors, to cause the receiver device to deliver the RLC UM packet, are individually or collectively configured to:
deliver the RLC UM packet within starting a reassembly timer further in connection with receiving all of a plurality of RLC UM protocol data units (PDUs) associated with the RLC UM SN.

15. The receiver device of claim 12, wherein the one or more processors are individually or collectively configured to:
determine that the RLC UM SN is not an expected next RLC UM SN in connection with detecting the gap between the RLC UM SN and the previous RLC UM SN.

16. The receiver device of claim 12, wherein the one or more processors, to cause the receiver device to deliver the RLC UM packet, are individually or collectively configured to:
deliver the RLC UM packet from an RLC layer of the receiver device to a PDCP layer of the receiver device.

17. The receiver device of claim 12, wherein the one or more processors, to cause the receiver device to deliver the RLC UM packet, are individually or collectively configured to:
deliver data included in the RLC UM packet to an application executing on the receiver device.

18. A receiver device for wireless communication, comprising:
one or more memories; and
one or more processors, coupled to the one or more memories, configured to cause the receiver device to:
receive segments of a radio link control (RLC) unacknowledged mode (UM) packet associated with an RLC UM sequence number (SN); and
deliver the RLC UM packet without starting a reassembly timer in connection with detection, using an artificial intelligence (AI) or machine learning (ML) (AI/ML) model, that a gap between the RLC UM SN and a previous RLC UM SN, associated with a previously received RLC UM packet, corresponds to an RLC UM SN jump across different component carriers (CCs) of a plurality of CCs.

19. The receiver device of claim 18, wherein the AI/ML model detects that the gap between the RLC UM SN and the previous RLC UM SN corresponds to the RLC UM SN jump across the different CCs based at least in part on at least one of a scheduling pattern or latency requirements of a quality of service (QoS) flow mapped to a radio bearer associated with the RLC UM packet.

20. The receiver device of claim 18, wherein the one or more processors, to cause the receiver device to deliver the RLC UM packet, are individually or collectively configured to:
deliver the RLC UM packet within starting a reassembly timer further in connection with receiving all of a plurality of RLC UM protocol data units (PDUs) associated with the RLC UM SN.
